(19) United States
(12) Patent Application Publication
(10) Pub. No.: US 2016/0026637 A1
(43) Pub. Date: Jan. 28, 2016

(54) SEARCH METHOD, SEARCH DEVICE, AND STORAGE MEDIUM

(71) Applicant: FUJITSU LIMITED, Kawasaki-shi (JP)

(72) Inventors: Shinya Kitajima, lnagi (JP); Shinji Kikuchi, Yokohama (JP); YASUHIDE MATSUMOTO, Kawasaki (JP)

(21) Appl. No.: 14/750,304

(22) Filed: Jun. 25, 2015

(30) Foreign Application Priority Data
Jul. 28, 2014 (JP) 2014-153306

(51) Int. Cl. G06F 17/30

(52) U.S. Cl. CPC G06F 17/3053

(57) ABSTRACT

A search method includes: extracting processes from a target operation manual from which automation software that is obtained by converting, into commands, the processes included in the target operation manual describing a procedure for configuring settings in an information processing device is generated; comparing the processes extracted from the target operation manual with a plurality of processes included in each of a plurality of existing operation manuals in a storage storing the existing operation manuals and automation software generated from the existing operation manuals and associated with the existing operation manuals while maintaining the orders of the processes; calculating first similarities that are similarities between the existing operation manuals and the target operation manual based on the comparing; and searching, based on the calculated first similarities, an existing operation manual similar to the target operation manual and automation software associated with the existing operation manual and stored in the storage.

### CROSS-REFERENCE TO RELATED APPLICATION

This application is based upon and claims the benefit of priority of the prior Japanese Patent Application No. 2014-153306 filed on Jul. 28, 2014, the entire contents of which are incorporated herein by reference.

### FIELD

The embodiments discussed herein are related to a search method, a search device, and a storage medium.

### BACKGROUND

In multiple information processing devices included in a system, the same predetermined settings such as the installation of software, various settings, and changes of settings are configured in some cases, for example. Traditionally, in order to configure settings in the information processing devices, an operator references an operation manual describing a procedure for the settings to be configured in the information processing devices and sequentially configures the predetermined settings in the multiple information processing devices in accordance with the operation manual.

Systems, however, have become larger. Thus, if the operator goes to locations at which the information processing devices are to be installed and configures the predetermined settings in accordance with the operation manual, the cost of the task is large. Recently, automation software for automating processes described in an operation manual is generated from the operation manual and executed in information processing devices to be subjected to settings and automatically configures the settings in the information processing devices. The automation software includes multiple statements (commands) for executing the processes described in the operation manual and is stored with a simple description of the automation software.

Related arts are Japanese Laid-open Patent Publications Nos. 2012-190284, 2013-196468, 2000-222215, 2013-196006, and 2008-117029.

In the generation of automation software from a new operation manual, the number of processes related to automation may be reduced by referencing previously generated automation software.

It is, however, difficult to appropriately classify and manage automation software generated by different persons or to be applied to different devices. Thus, existing automation software to be referenced in order to generate the automation software from the new operation manual may not be found through a search, or a meaningless process may be executed in order to find the existing automation software through a search.

In addition, it is considered that automation software that is similar to the new operation manual is searched as automation software to be referenced. However, since a description format of the operation manual is different from a description format of the automation software, the automation software that is similar to the new operation manual may not be found through a search by simply comparing character strings.

### SUMMARY

According to an aspect of the invention, a search method includes: extracting a plurality of processes from a target operation manual from which automation software that is obtained by converting, into a plurality of commands, the plurality of processes included in the target operation manual describing a procedure for configuring settings in an information processing device is generated; comparing the plurality of processes extracted from the target operation manual with a plurality of processes included in each of a plurality of existing operation manuals stored in a storage device storing the existing operation manuals and automation software generated from the existing operation manuals and associated with the existing operation manuals while maintaining the orders of the pluralities of processes; calculating, by a processor, first similarities that are similarities between the existing operation manuals and the target operation manual based on the comparing; and searching, based on the calculated first similarities, an existing operation manual similar to the target operation manual and automation software associated with the existing operation manual and stored in the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an operation manual;

FIG. 2 is a diagram describing the automation of the operation manual;

FIG. 3 illustrates an example of an automation script;

FIG. 4 is a schematic diagram describing a search of an automation script;

FIG. 5 is a schematic diagram describing a search of an automation script;

FIG. 6 is a functional block diagram of a search device according to a first embodiment;

FIG. 7 illustrates an example of an operation manual database (DB);

FIG. 8 illustrates an example of an automation script DB according to the first embodiment;

FIG. 9 is a diagram describing the extraction of commands from an operation manual;

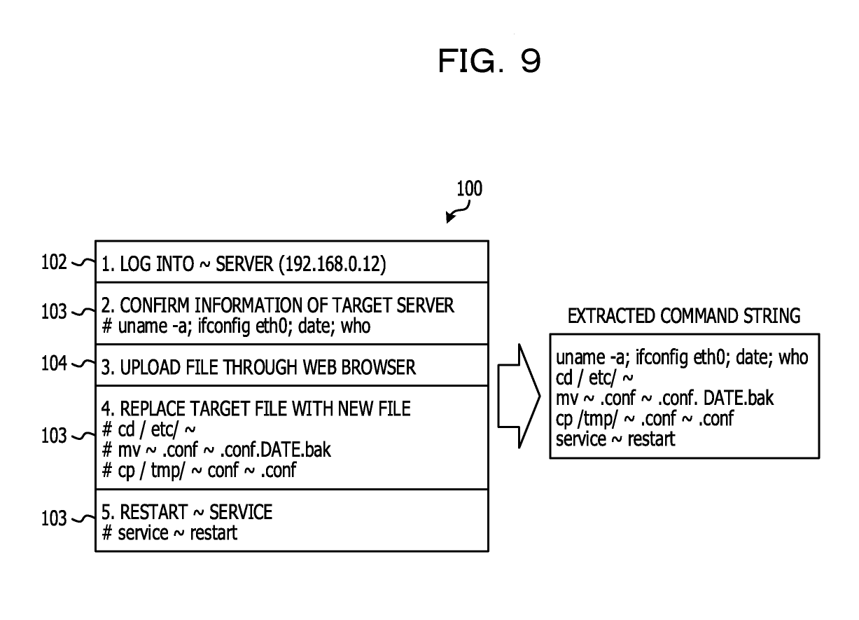

FIG. 10 illustrates an example of an operation manual command DB;

FIG. 11 is a diagram describing the calculation of similarities between commands;

FIG. 12 is a diagram describing the association of commands;

FIG. 13 is a diagram describing the association of commands;

FIG. 14 is a diagram describing the calculation of file similarities;

FIG. 15 is a schematic block diagram of a computer that functions as the search device according to the first and second embodiments;

FIG. 16 is a flowchart of an example of a search process according to the first embodiment;

FIG. 17 is a functional block diagram of the search device according to the second embodiment;

FIG. 18 illustrates an example of an automation script DB according to the second embodiment;

FIG. 19 is a diagram describing the extraction of commands from an automation script;

FIG. 20 is a diagram describing a conversion definition of an automation script;

FIG. 21 illustrates an example of an automation script command DB;

FIG. 22 illustrates an example of an association information DB;

FIG. 23 is a diagram describing the presentation of associated commands;

FIG. 24 is a flowchart of an example of a process of associating existing operation manuals with automation scripts; and

FIG. 25 is a flowchart of the example of the process of associating the existing operation manuals with the automation scripts.

### DESCRIPTION OF EMBODIMENTS

According to an aspect of embodiments of a search method disclosed herein, existing automation software to be referenced in order to automate an operation manual may be found through a search. Hereinafter, an example of the embodiments is described in detail with reference to the accompanying drawings.

Before a detailed description of the embodiments, an operation manual assumed in the embodiments, an example of an automation script generated from the operation manual, and an outline of the embodiments are described. The automation script is an example of automation software described in claims.

The operation manual describes a procedure for settings to be configured in an information processing device to be subjected to the automation. The settings to be configured in the information processing device are an operation of additionally installing the information processing device, an update operation to be performed due to the addition of a function, an operation of fixing a failure, and the like. It is assumed that the operation manual is generated as a single file in a text format for a single operation group.

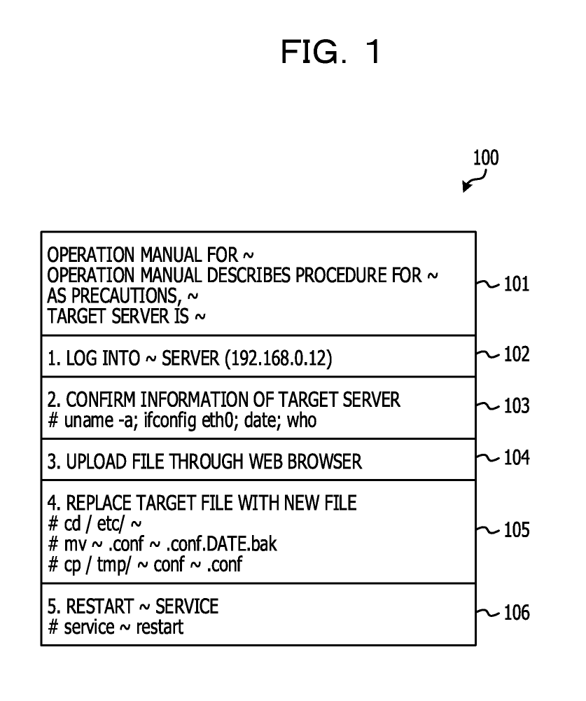

FIG. 1 illustrates an example of the operation manual according to the embodiments. An operation manual 100 includes a description 101 of an outline of the operation manual, an operator's operation 102, command strings 103, and a graphical user interface (GUI) operation 104. The description 101 of the outline is different from the operator's operation 102, the command strings 103, and the GUI operation 104 that describe a procedure for settings to be configured in an information processing device. The description 101 of the outline is a description of the overall operation manual, precautions, and the like. The description 101 of the outline is not subjected to automation.

The operator's operation 102 is a description, such as “log into server”, of an operation to be performed by an operator and is described in a natural language. The command strings 103 are descriptions of multiple statements (commands) representing processes to be executed in the information processing device. In FIG. 1, commands included in the command strings 103 are described while being segmented into rows starting with “#”, respectively. The GUI operation 104 is a description, such as “upload file through web browser”, representing an operation using a GUI. The GUI operation 104 is described in the natural language. The operator's operation 102, the command strings 103, and the GUI operation 104 are an example of a “plurality of processes” described in claims. The embodiments describe a case where the multiple commands included in the command strings 103 are treated as the “plurality of processes” described in claims.

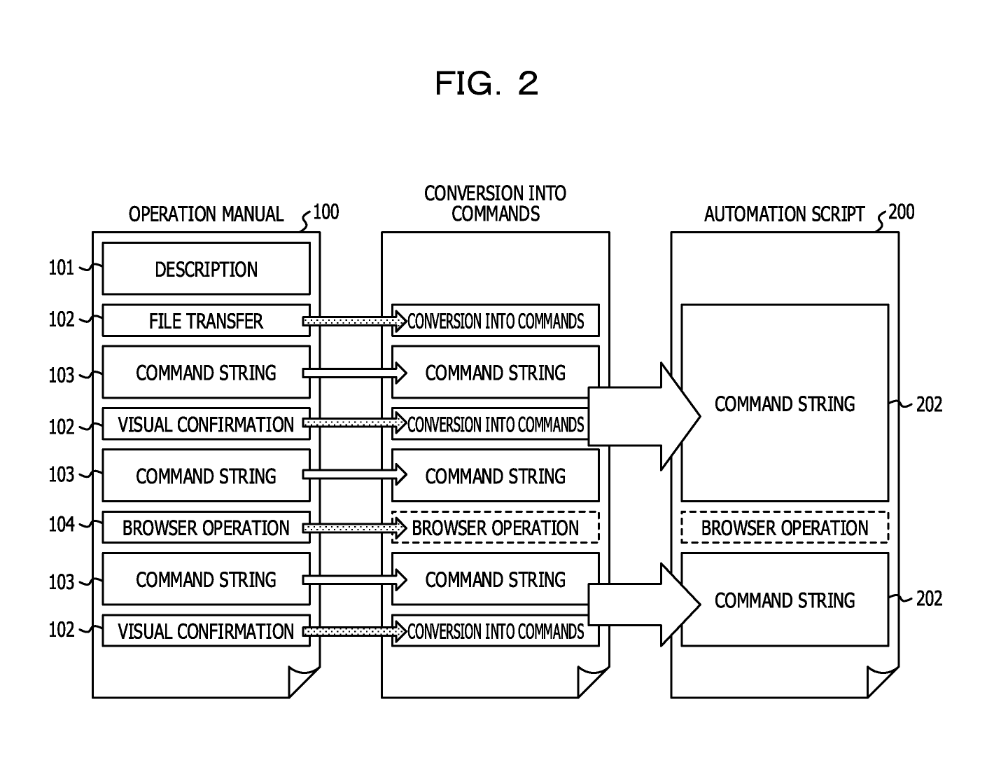

As illustrated in FIG. 2, a person who is in charge of the generation of an automation script performs the following automation for the operator's operation 102, the command strings 103, and the GUI operation 104 in order to generate an automation script 200. First, the command strings 103 are converted into command strings 202 in a format of the automation script 200. Next, the operator's operation 102 is converted into a command string 202 in the format of the automation script, while the command string 202 enables the same process to be executed. In addition, the GUI operation 104 is converted into a command string 202 in the format of the automation script, while the command string 202 enables the same process to be executed using an application programming interface (API) or the like. If a part of the operator's operation 102, the command strings 103, and the GUI operation 104 is not converted into a command string 202 in the format of the automation script, the automation script is divided at the part or an input waiting state is set and the automation script 200 is generated so as to ensure that an operation of the part is manually performed.

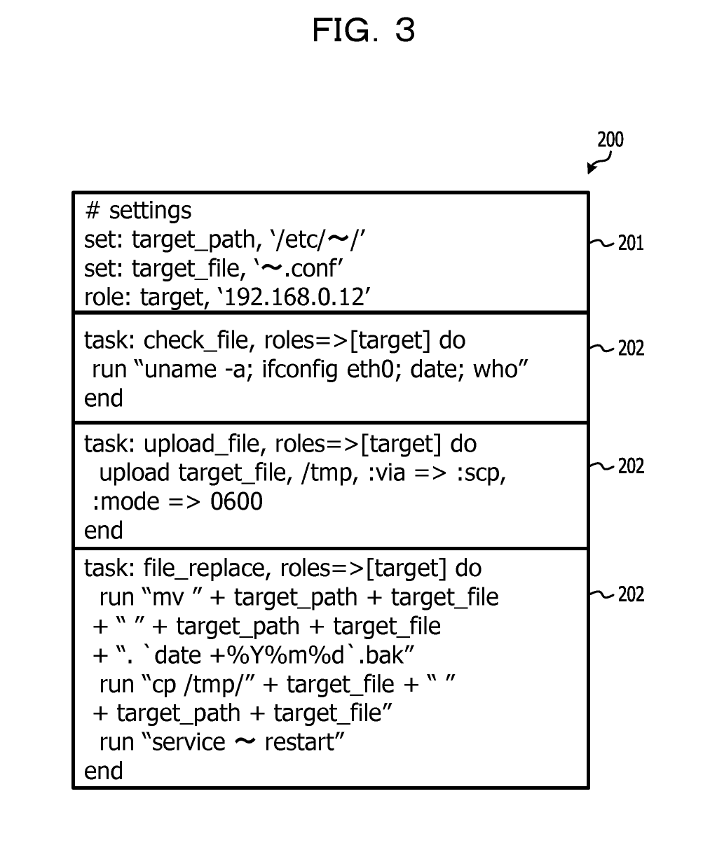

FIG. 3 illustrates an example of the generated automation script 200. The automation script 200 includes a conversion definition 201 for converting the descriptions of the operation manual 100 into the format of the automation script 200 and includes the command strings 202 formed by converting the descriptions of the operation manual 100 into commands. The operation manual 100 does not include a variable in general. This is due to the fact that a person executes the commands described in the operation manual 100. The automation script 200 includes variables in consideration of maintenance in many cases. Thus, the conversion definition 201 defines a rule for converting specific character strings described in the operation manual 100 into generalized variables, for example.

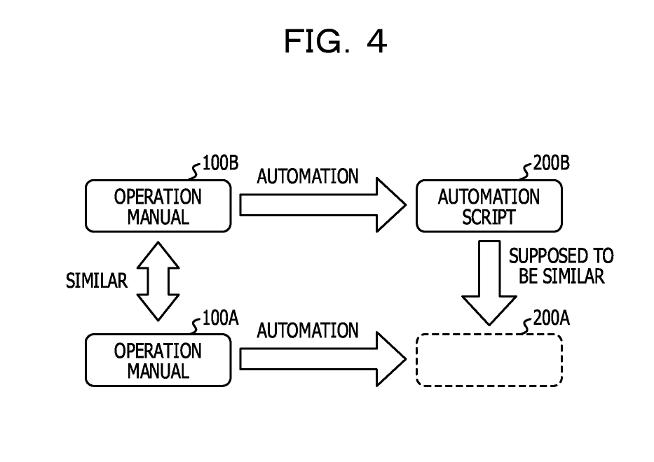

As illustrated in FIG. 4, it is considered that an automation script 200A is generated from an operation manual 100 (hereinafter referred to as “target operation manual 100A”) to be subjected to automation. In addition, it is assumed that an operation manual 100 (hereinafter referred to as “existing operation manual 100B”) from which an automation script is already generated is similar to the target operation manual 100A. In this case, the automation script 200A to be generated from the target operation manual 100A is likely to be similar to an automation script 200B already generated from the existing operation manual 100B. Thus, in the generation of the automation script 200A from the operation manual 100, the number of operations for generating the automation script 200A may be reduced by using parts included in the automation script 200B for the automation script 200A to be newly generated.

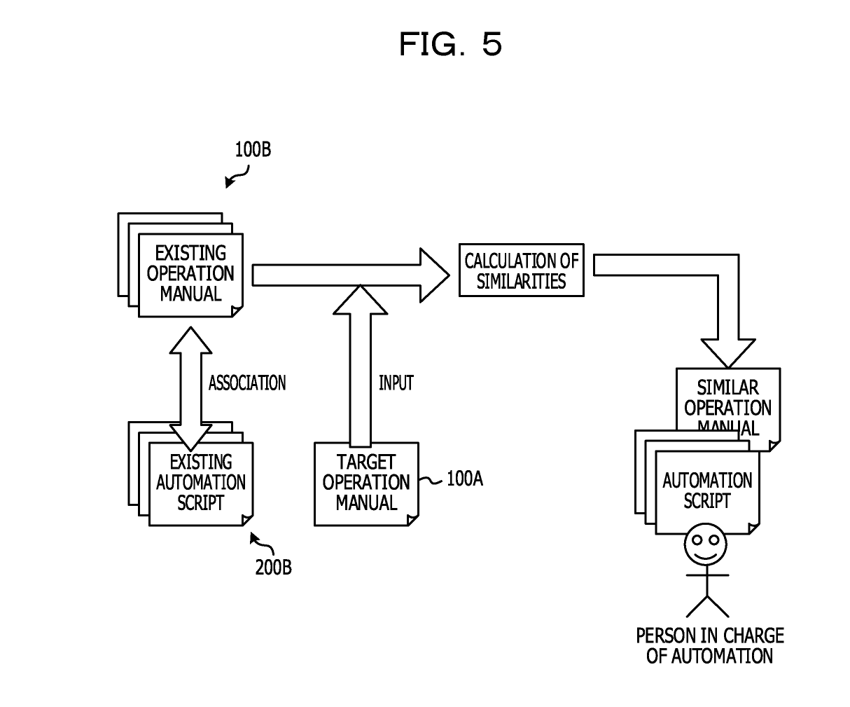

In the embodiments, as illustrated in FIG. 5, existing operation manuals 100B and automation scripts 200B generated from the existing operation manuals 100B are associated and stored. Then, when the target operation manual 100A is input by the person in charge of automation, similarities between the target operation manual 100A and the existing operation manuals 100B are calculated. An existing operation manual 100B that is similar to the target operation manual 100A is searched, and an automation script 200B associated with the searched existing operation manual 100B is presented to the person in charge of automation.

Hereinafter, the embodiments are described. In the following description, if the target operation manual 100A and the existing operation manuals 100B are not distinguished, the operation manuals 100A and 100B are merely referred to as “operation manuals 100”. In addition, if the automation script 200A and the automation scripts 200B are not distinguished, the automation scripts 200A and 200B are merely referred to as “automation scripts 200”.

### First Embodiment

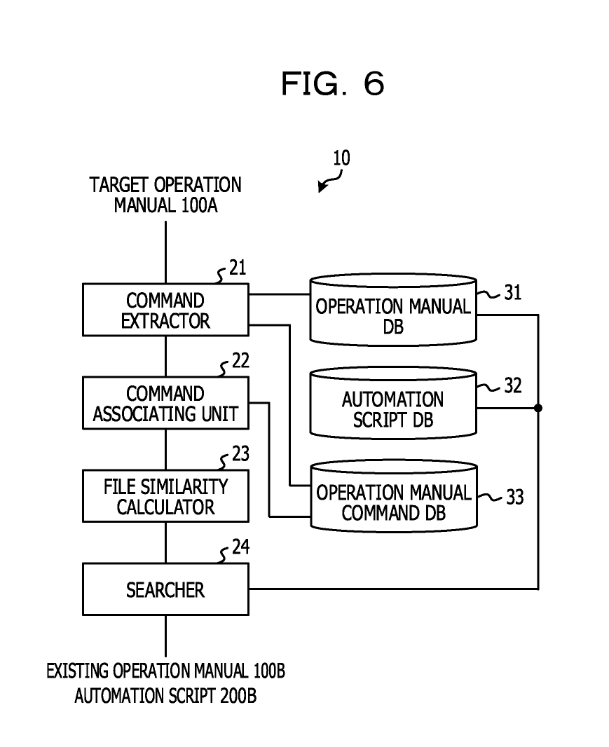

As illustrated in FIG. 6, a search device 10 according to a first embodiment includes a command extractor 21, a command associating unit 22, a file similarity calculator 23, and a searcher 24. An operation manual database (DB) 31, an automation script DB 32, and an operation manual command DB 33 are stored in a predetermined storage region of the search device 10.

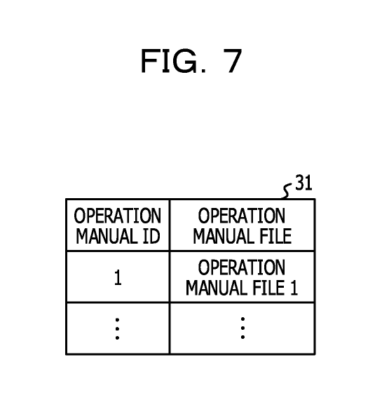

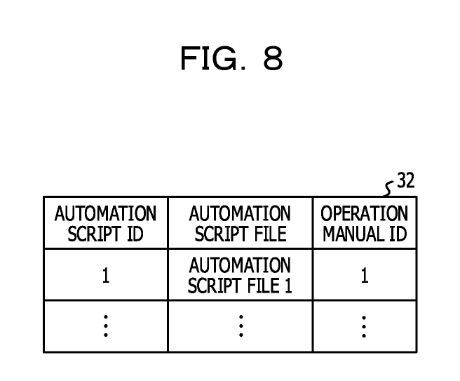

Operation manual IDs that identify the existing operation manuals 100B are given to files representing the existing operation manuals 100B and are stored in the operation manual DB 31, as illustrated in FIG. 7, for example. Automation script IDs that identify the automation scripts 200B are given to files representing the automation scripts 200B and are stored in the automation script DB 32, as illustrated in FIG. 8, for example. In the automation script DB 32, the operation manual IDs of the existing operation manuals 100B from which the automation scripts 200B are generated are stored. Thus, the associations of the existing operation manuals 100B with the automation scripts 200B generated from the existing operation manuals 100B are identified. In order to simplify the following description, the first embodiment describes a case where each existing operation manual 100B is associated with a respective automation script 200B.

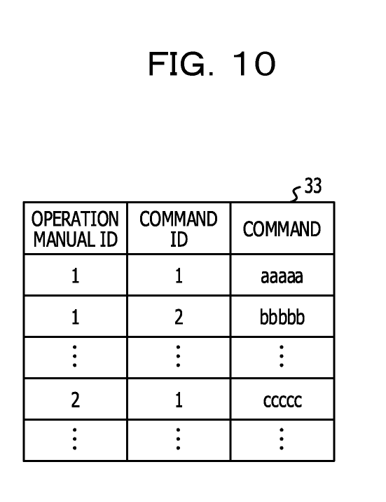

The command extractor 21 extracts commands from command strings 103 included in the input target operation manual 100A and command strings 103 included in the existing operation manuals 100B stored in the operation manual DB 32. A rule for identifying descriptions of commands based on a description format of the operation manuals may be defined in advance, and the commands may be extracted in accordance with the rule. For example, as described above, if the commands included in the command strings 103 are described while being segmented into rows starting with “#”, respectively, each command may be extracted as a single command starting from a character next to “#” and ending at the end of a row. For example, as illustrated in FIG. 10, the command extractor 21 gives command IDs to the extracted commands in order of the appearance of the commands within the operational manuals 100, associates the extracted commands with the operation manual IDs of the operation manuals 100 from which the commands are extracted, and causes the commands, the command IDs, and the operation manual IDs to be stored in the operation manual command DB 33.

The command associating unit 22 associates a command extracted from the target operation manual 100A with a command extracted from each of the existing operation manuals 100B in order to calculate similarities between the target operation manual 100A and the existing operation manuals 100B. In this case, the commands have a similarity that is equal to or larger than a predetermined threshold THc and largest and are associated with each other so as to maintain the order of commands included in the target operation manual 100A and the order of commands included in the existing operation manual 100B.

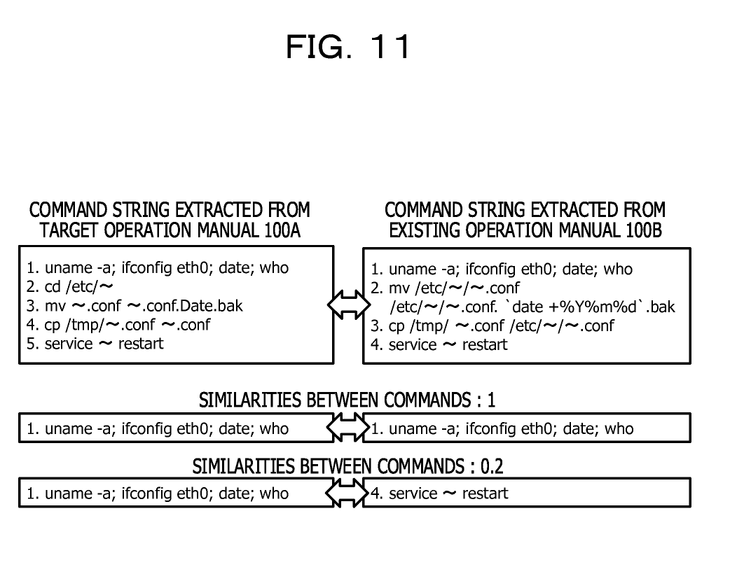

Specifically, the command associating unit 22 acquires, from the operation manual DB 33, the command strings extracted from the target operation manual 100A and command strings extracted from each of the existing operation manuals 100B. Then, the command associating unit 22 calculates similarities between commands included in the acquired command strings, as illustrated in FIG. 11. The similarities between the commands may be calculated by comparing character strings of the commands and quantifying the character strings. For example, a similarity between two commands to be compared may be calculated by subtracting, from 1, a value obtained by dividing a Levenshtein distance between the two commands by the number of characters of a longer one (including a larger number of characters) of command strings including the commands. The Levenshtein distance is a value representing the difference between two character strings and is the minimum number of processes that are the insertion, deletion, and substitution of characters and are executed to convert a certain character string into another character string. The similarity between the commands may be normalized to a value in a range of 0 to 1 by dividing the Levenshtein distance by the number of the characters of the longer command string. The similarities between the commands are an example of a “similarity between processes” that is described in claims.

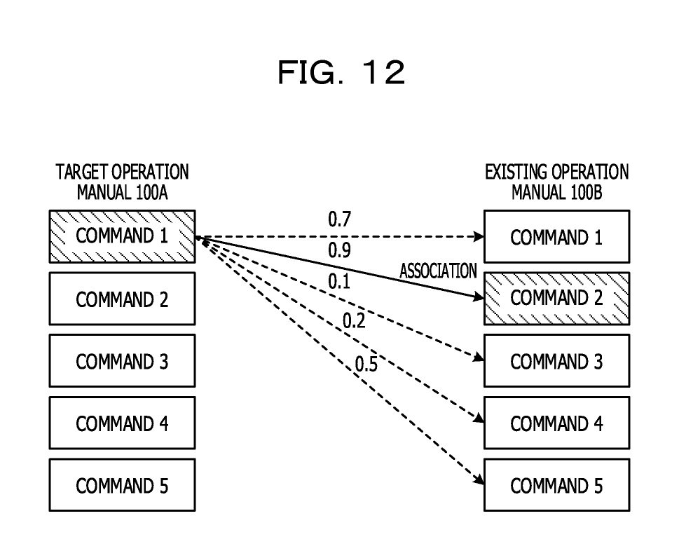

As illustrated in FIG. 12, the command associating unit 22 associates, in order from the top command of the target operation manual 100A, a command extracted from the target operation manual 100A with a command that is extracted from an existing operation manual 100B and of which a similarity with the command of the target operation manual 100A is equal to or larger than the predetermined threshold THc and is largest among similarities between the command of the target operation manual 100A and commands of the existing operation manual 100B. In an example illustrated in FIG. 12, five commands are included in a command string extracted from the target operation manual 100A, and five commands are included in a command string extracted from the existing operation manual 100B. In FIG. 12, values that are illustrated with arrows connecting commands to each other represent similarities between the top command of the target operation manual 100A and the commands of the existing operation manual 100B. Commands may be associated with each other if a similarity between the commands is equal to or larger than the predetermined threshold THc. This is due to the fact that even if a certain command of an existing operation manual 100B has the largest similarity with a command of the target operation manual 100A among similarities between the command of the target operation manual 100A and commands of the existing operation manual 100B, the certain command may be totally different from the command of the target operation manual 100A. Thus, if a similarity between commands is smaller than the threshold THc, the commands are not associated with each other. The threshold THc is set in advance based on accuracy requested for the search device or the like.

In the example illustrated in FIG. 12, a command that is extracted from the existing operation manual 100B and has the largest similarity with the command 1 of the target operation manual 100 among similarities between the command 1 and the commands extracted from the existing operation manual 100B is a command 2, and the similarity between the commands 1 and 2 is 0.9. If 0.9 is equal to or larger than the threshold THc for similarities between commands, the command 1 of the target operation manual 100A and the command 2 of the existing operation manual 100B are associated with each other. Specifically, a pair of the operation manual ID of the target operation manual 100A and the command ID of the command 1, and a pair of the operation manual ID of the existing operation manual 100B and the command ID of the command 2, are associated with each other and temporarily stored in the predetermined storage region.

The command associating unit 22 associates a next command of the target operation manual 100A with a command of the existing operation manual 100B in the same manner as described above. In this case, in order to maintain the orders of the commands included in the command strings, a command that is included in the existing operation manual 100B and precedes the command included in the existing operation manual 100B and already associated with the command of the target operation manual 100A is excluded from commands to be associated. This is due to the fact that it is considered that the operation manuals 100 almost do not include a conditional branch such as an if statement, procedures for settings to be configured in an information processing device are sequentially described from the top to the bottom in the operation manuals 100 in order of the execution of the procedures in many cases, and the orders in which commands are executed are not normally changed.

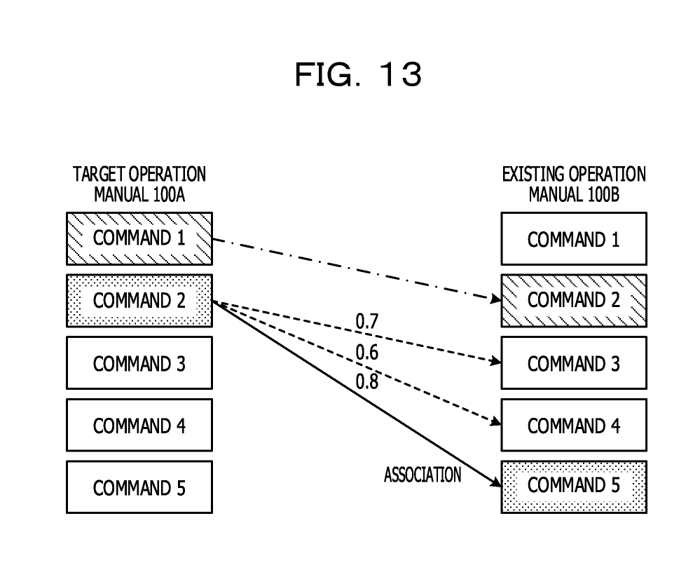

In the example illustrated in FIG. 12, the command 1 of the target operation manual 100A and the command 2 of the existing operation manual 100B are associated with each other. As illustrated in FIG. 13, the next command 2 of the target operation manual 100A is to be associated with any of commands 3, 4, and 5 of the existing operation manual 100B. Thus, the commands may be associated with each other so as to maintain the orders of the commands included in the command strings, the number of times of the comparison (calculation of a similarity between commands) of commands may be reduced, and a processing speed may be increased.

The file similarity calculator 23 calculates file similarities between the target operation manual 100A and the existing operation manuals 100B based on the results of associating commands of the target operation manual 100A with commands of the existing operation manuals 100B by the command associating unit 22. The file similarities between the target operation manual 100A and the existing operation manuals 100B are an example of “similarities between operation manuals” that are described in claims. As the number of commands included in an existing operation manual 100B and associated with commands of the target operation manual 100A is larger, the file similarity between the target operation manual 100A and the existing operation manual 100B may increase. For example, the file similarity between the target operation manual 100A and the existing operation manual 100B may be a value obtained by dividing the number of commands included in the existing operation manual 100B and associated with commands included in the target operation manual 100A by a larger one of the number of the commands included in the target operation manual 100A and the number of commands included in the existing operation manual 100B.

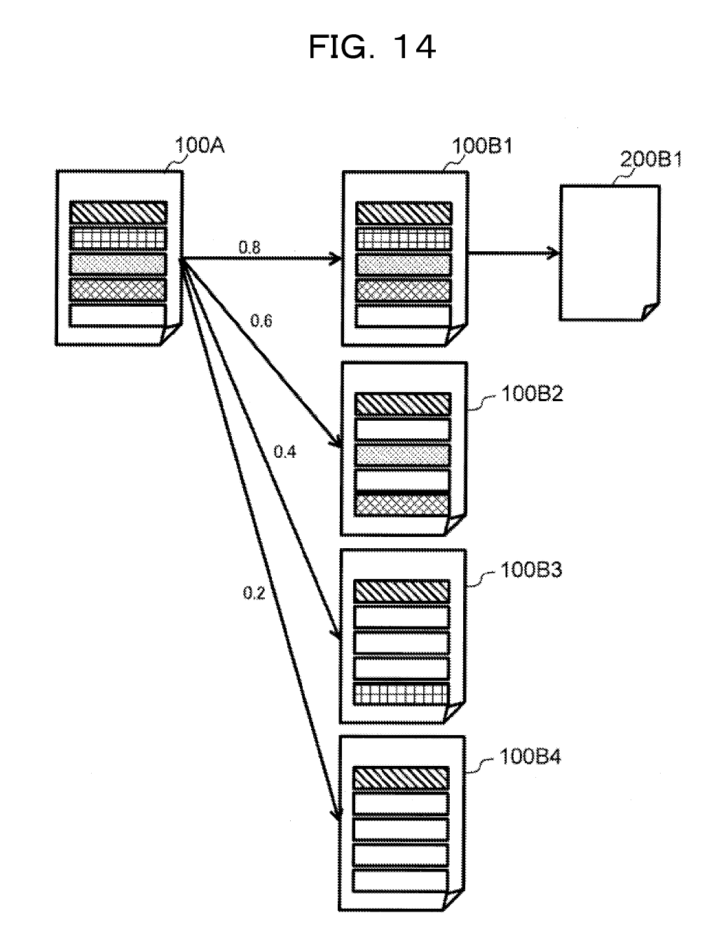

For example, as illustrated in FIG. 14, it is assumed that existing operation manuals 100B1, 100B2, 100B3, and 100B4 each have at least one command associated with a command of the target operation manual 100A. In FIG. 14, blocks included in the operation manuals 100 are commands. In FIG. 14, commands represented by the same design are associated with each other, while commands represented by white blocks are commands that are not associated. In FIG. 14, the operation manuals 100 each have five commands. In this case, four commands of the target operation manual 100A are associated with four commands of the existing operation manual 100B1, respectively, and thus a file similarity between the target operation manual 100A and the existing operation manual 100B1 is 4/5=0.8. The file similarity calculator 23 calculates file similarities between the target operation manual 100A and the other existing operation manuals 100B in the aforementioned manner.

The file similarity calculator 23 associates the calculated file similarities with the operation manual ID of the target operation manual 100A and the operation manual IDs of the existing operation manuals 100B and causes the file similarities and the operation manual IDs to be temporarily stored in the predetermined storage region.

The searcher 24 searches, as an existing operation manual 100B similar to the target operation manual 100A, an existing operation manual 100B of which a file similarity, calculated by the file similarity calculator 23, with the target operation manual 100A is equal to or larger than a predetermined threshold THf1. Specifically, the searcher 24 searches the existing operation manual 100B from the operation manual DB 31 based on an operation manual ID, associated with the file similarity equal to or larger than the threshold THf1, of the existing operation manual 100B.

Even if a file similarity between the target operation manual 100A and an existing operation manual 100B is largest among the calculated file similarities, the existing operation manual 100B may not be similar to the target operation manual 100A. Thus, the existing operation manual 100B of which the file similarity is equal to or larger than the threshold THf1 is selected. Thus, if a file similarity between the target operation manual 100A and an existing operation manual 100B is smaller than the threshold THf1, the existing operation manual 100B is not searched as an existing operation manual 100B similar to the target operation manual 100A. The threshold THf1 is set in advance based on the accuracy requested for the search device or the like.

The number of existing operation manuals 100B similar to the target operation manual 100A may be 1 or more. For example, a single existing operation manual 100B of which a file similarity with the target operation manual 100A is equal to or larger than the predetermined threshold THf1 and largest among the calculated file similarities may be searched, or all existing operation manuals 100B of which file similarities with the target operation manual 100A are equal to or larger than the predetermined threshold THf1 may be searched. Alternatively, existing operation manuals 100B of which file similarities with the target operation manual 100A are equal to or larger than the predetermined threshold THf1 and are the top N file similarities may be searched. In the example illustrated in FIG. 14, if the threshold is 0.6 and N is 3, the existing operation manuals 100B1 and 100B2 are searched.

The searcher 24 searches, from the automation script DB 32, an automation script 200B associated with the searched existing operation manual 100B similar to the target operation manual 100A. Specifically, the searcher 24 searches the automation script 200B associated with an operation manual ID stored in an “operation manual ID” item of the automation script DB 32 and identifying the searched existing operation manual 100B. The example illustrated in FIG. 14 assumes that the existing operation manual 100B1 is searched as the existing operation manual 100B similar to the target operation manual 100A. In this case, an automation script 200B1, which is generated from the existing operation manual 100B1, associated with the operation manual ID of the existing operation manual 100B1, and stored in the automation script DB 32, is searched.

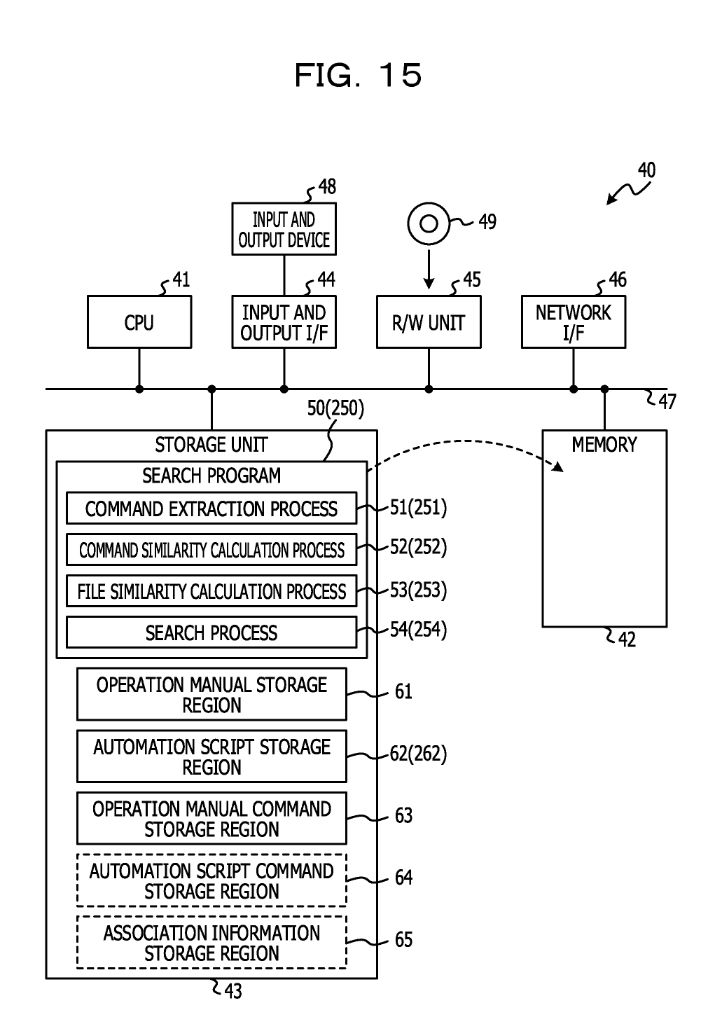

The search device 10 may be achieved by a computer 40 illustrated in FIG. 15, for example. The computer 40 includes a CPU 41, a memory 42 serving as a temporary storage region, and a nonvolatile storage unit 43. The computer 40 also includes an input and output interface (I/F) 44 to which an input device 48 is connected. In addition, the computer 40 includes a reading and writing (R/W) unit 45 configured to control reading and writing of data from and in a storage medium 49. The computer 40 includes a network I/F 46 to be connected to a network such as the Internet. The CPU 41, the memory 42, the storage unit 43, the input and output I/F 44, the R/W unit 45, and the network I/F 46 are connected to each other through a bus 47.

The storage unit 43 may be achieved by a hard disk drive (HDD), a solid state drive (SSD), a flash memory, or the like. A search program 50 that causes the computer 40 to function as the search device 10 is stored in the storage unit 43 serving as a storage medium. In addition, the storage unit 43 includes an operation manual storage region 61 for storing information forming the operation manual DB 31, an automation script storage region 62 for storing information forming the automation script DB 32, and an operation manual command storage region 63 for storing information forming the operation manual command DB 33.

The CPU 41 reads the search program 50 into the storage unit 43, loads the search program 50 into the memory 42, and sequentially executes processes included in the search program 50. In addition, the CPU 41 reads the information stored in the operation manual storage region 61 and loads, into the memory 42, the read information as the operation manual DB 31 illustrated in FIG. 7, for example. In addition, the CPU 41 reads the information stored in the automation script storage region 62 and loads, into the memory 42, the read information as the automation script DB 32 illustrated in FIG. 8, for example. In addition, the CPU 41 reads the information stored in the operation manual storage region 63 and loads, into the memory 42, the read information as the operation manual command DB 33 illustrated in FIG. 10, for example.

The search program 50 includes a command extraction process 51, a command association process 52, a file similarity calculation process 53, and a search process 54. The CPU 41 operates as the command extractor 21 illustrated in FIG. 6 by executing the command extraction process 51. In addition, the CPU 41 operates as the command associating unit 22 illustrated in FIG. 6 by executing the command association process 52. In addition, the CPU 41 operates as the file similarity calculator 23 illustrated in FIG. 6 by executing the file similarity calculation process 53. In addition, the CPU 41 operates as the searcher 24 illustrated in FIG. 6 by executing the search process 54. Thus, the computer 40 that executes the search program 50 functions as the search device 10.

The search device 10 may be achieved by a semiconductor integrated circuit, for example. Specifically, the search device 10 may be achieved by an application specific integrated circuit (ASIC) or the like.

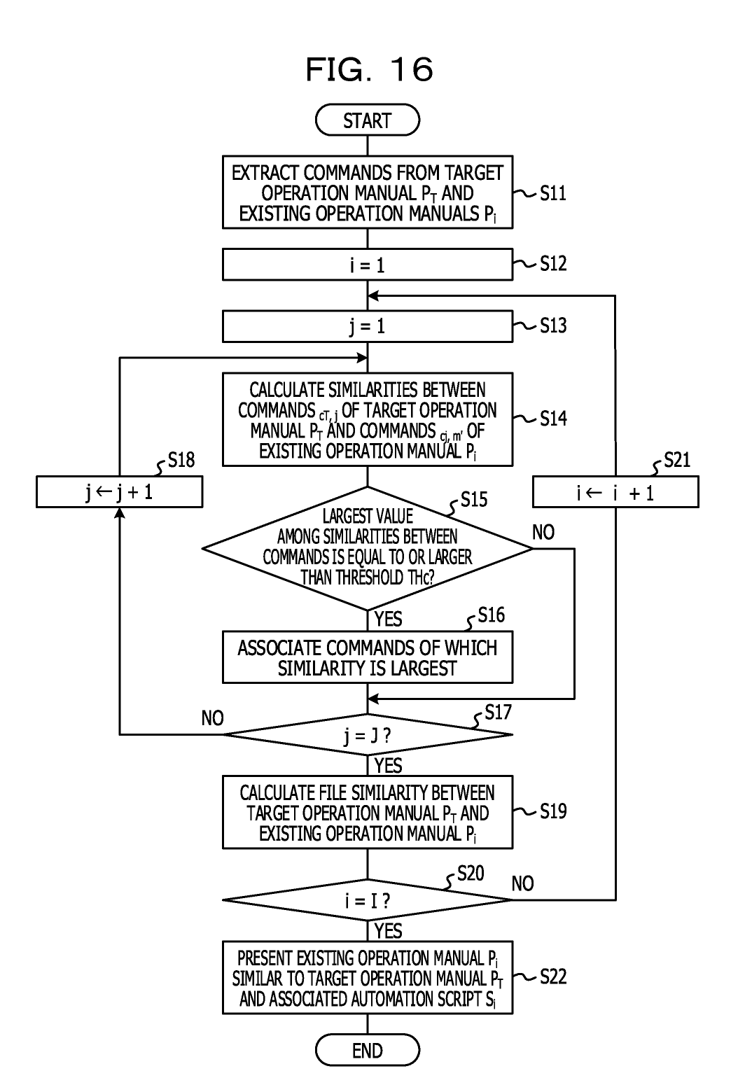

Next, effects of the search device 10 according to the first embodiment are described. It is assumed that multiple existing operation manuals 100B are stored in the operation manual DB 31 and that automation scripts associated with the existing operation manuals 100B stored in the operation manual DB 31 are stored in the automation script DB 32. In this state, when the person in charge of automation inputs the target operation manual 100A to the search device 10, a search process illustrated in FIG. 16 is executed in the search device 10.

The following assumes that sequential operation manual IDs 1, 2, . . . are given to the existing operation manuals 100B stored in the operation manual DB 31. An existing operation manual 100B with an operation manual ID=i is referred to as an “existing operation manual Pᵢ”. In addition, an automation script generated from the existing operation manual Pᵢ is referred to as an “automation script Sᵢ”, and the target operation manual 100A is referred to as a “target operation manual P_{T}”. In addition, sequential command IDs 1, 2, . . . are given to commands extracted from each of the target operation manual P_{T} and existing operation manuals Pᵢ. In addition, a command with a command ID=j extracted from the target operation manual P_{T} is referred to as a “command c_{T,j}”, and a command with a command ID=m extracted from an existing operation manual Pᵢ is referred to as a “command c_{i, m}”.

In step S11 of the search process illustrated in FIG. 16, the command extractor 21 extracts the commands from the command strings 103 included in the input target operation manual P_{T}. In addition, the command extractor 21 extracts the commands from the command strings 103 included in the existing operation manuals Pᵢ stored in the operation manual DB 31. Then, the command extractor 21 gives command IDs to the extracted commands in order of the appearance of the commands within the operation manuals 100, associates the command IDs with operation manual IDs of the operation manuals 100 from which the commands are extracted, and causes the commands, the command IDs, and the operation manual IDs to be stored in the operation manual command DB 33.

Next, in step S12, the command associating unit 22 sets, to 1, a variable i for identifying an existing operation manual Pᵢ to be processed. The variable i is 1, 2, . . . , I, while I is the number of the existing operation manuals 100B. Next, in step S13, the command associating unit 22 sets, to 1, a variable j for identifying a command c_{T,j} that is among the commands included in the target operation manual PT and is to be processed. The variable j is 1, 2, . . . , J, while J is the number of the commands included in the target operation manual P_{T}.

Next, in step S14, the command associating unit 22 calculates similarities between the command c_{T,j} of the target operation manual P_{T} and commands c_{i, m′} of the existing operation manual Pᵢ. In this case, m is 1, 2, . . . , M(i), and M(i) is the number of the commands included in the existing operation manual Pᵢ. In addition, m′ is in the range of m and represents the commands excluding a command preceding a command associated with the command c_{T,j} of the target operation manual P_{T}. For example, if m=1, 2, . . . , 5, and the command associated with the command C_{T}, of the target operation manual P_{T} and having the largest command ID is a command c_{i, 2}, m′=3, 4, 5.

Next, in step S15, the command associating unit 22 determines whether or not the largest value among the similarities calculated in the aforementioned step S14 is equal to or larger than the threshold THc. If the largest value among the similarities is equal to or larger than the threshold THc, the process proceeds to step S16. In step S16, the command associating unit 22 associates a pair of the operation manual ID of the target operation manual P_{T} and the command ID (j) of the command c_{T,j} with a pair of the operation manual ID (i) of the existing operation manual Pᵢ and the command ID of a command c_{i,m′} of which a similarity with the command c_{T,j} is largest among the calculated similarities. Then, the command associating unit 22 causes the results of the association to be temporarily stored in the predetermined storage region, and the process proceeds to step S17. On the other hand, if the command associating unit 22 determines that the largest value among the similarities is smaller than the threshold THc in the aforementioned step S15, the process skips step S16 and proceeds to step S17.

In step S17, the command associating unit 22 determines whether or not the variable j reaches J, and the command associating unit 22 thereby determines whether or not the command associating unit 22 executes a process of associating all the commands included in the target operation manual P_{T} with commands included in the existing operational manual Pᵢ. If the variable j does not reach J, the process proceeds to step S18, the command associating unit 22 increments the variable j by 1, and the process returns to step S14. If the variable j reaches J, the process proceeds to step S19.

In step S19, the file similarity calculator 23 calculates a file similarity between the target operation manual P_{T} and the existing operation manual Pᵢ based on the results of associating commands of the target operation manual P_{T} and existing operation manual Pᵢ by the command associating unit 22. For example, as the file similarity, a value obtained by dividing the number of commands included in the existing operation manual Pᵢ and associated with commands included in the target operation manual P_{T} by a larger one of the number of all the commands included in the target operation manual P_{T} and the number of all commands included in the existing operation manual Pᵢ is calculated. The file similarity calculator 23 associates the calculated file similarity with the operation manual ID of the target operation manual P_{T} and the operation manual ID (i) of the existing operation manual Pᵢ and causes the calculated file similarity, the operation manual ID of the target operation manual P_{T}, and the operation manual ID (i) of the existing operation manual Pᵢ to be temporarily stored in the predetermined storage region.

Next, in step S20, the file similarity calculator 23 determines whether or not the variable i reaches I, and the file similarity calculator 23 thereby determines whether or not the file similarity calculator 23 calculates file similarities between the target operation manual P_{T} and all the existing operation manuals Pᵢ stored in the operation manual DB 31. If the variable i does not reach I, the process proceeds to step S21, the file similarity calculator 23 increments the variable i by 1, and the process returns to step S13. If the variable i reaches I, the process proceeds to step S22.

In step S22, the searcher 24 searches, based on an operation manual ID (i) identifying an existing operation manual Pᵢ and associated with a file similarity that is among the file similarities calculated in the aforementioned step S19 and is equal to or larger than the threshold THf1, the interested existing operation manual Pᵢ from the operation manual DB 31. For example, the searcher 24 may search a single existing operation manual Pᵢ of which a file similarity with the target operation manual P_{T} is equal to or larger than the threshold THf1 and is largest among the calculated file similarities. Alternatively, the searcher 24 may search all existing operation manuals Pᵢ of which file similarities with the target operation manual P_{T} are equal to or larger than the threshold THf1, or the searcher 24 may search all existing operation manuals Pᵢ of which file similarities with the target operation manual P_{T} are equal to or larger than the threshold THf1 and are the top N file similarities.

In addition, the searcher 24 searches an automation script Sᵢ associated with the operation manual ID of the searched existing operation manual Pᵢ and stored in the automation script DB 32. Then, the searcher 24 displays the searched existing operation manual Pᵢ and the searched automation script Sᵢ on a display device, presents the searched existing operation manual Pᵢ and the searched automation script Sᵢ to the person in charge of automation, and terminates the process.

As described above, the search device 10 according to the first embodiment associates the existing operation manuals with the automation scripts generated from the existing operation manuals and stores the existing operation manuals and the automation scripts. When the target operation manual to be subjected to automation is input, the search device 10 associates commands while maintaining the orders of commands included in command strings and corresponding to multiple processes included in each of the operation manuals and searches an existing operation manual similar to the target operation manual based on the results of the association. Then, the search device 10 presents the searched existing operation manual and an automation script associated with the existing operation manual. Since a description format of an operation manual is different from a description format of an automation script, a similarity between the operation manual and the automation script may not be accurately calculated by simply comparing character strings. In the present embodiment, however, the similarities between the operation manuals of the same description format are calculated, as described above. Then, an existing operation manual that is similar to the target operation manual is searched, and an automation script associated with the searched operation manual is searched. Thus, an existing automation script to be referenced for automation of the operation manual may not be found through a search by simply comparing character strings of the target operation manual and existing automation script, but may be found through a search in the first embodiment.

The first embodiment describes the case where each existing operation manual is associated with a respective automation script generated from the existing operation manual. Each existing operation manual, however, may be associated with a number N of automation scripts. Alternatively, a number N of existing operation manuals may be associated with a single automation script or may be associated with a number N of automation scripts.

If each existing operation manual is associated with multiple automation scripts, all automation scripts associated with the operation manual ID of a searched existing operation manual similar to the target operation manual may be searched.

### Second Embodiment

Next, a second embodiment is described. The first embodiment describes the case where the existing operation manuals 100B and the automation scripts 200B generated from the existing operation manuals 100B are associated and stored. The existing operation manuals 100B and the automation scripts 200B are not considered to be associated and managed in many cases in light of the number of processes for the management and the fact that an operation manual is not referenced for an automated task. The second embodiment describes a case where the association of the existing operation manuals 100B with the automation scripts 200B is executed.

Parts that are the same as the search device 10 according to the first embodiment are represented by the same reference numerals as the first embodiment, and a detailed description thereof is omitted.

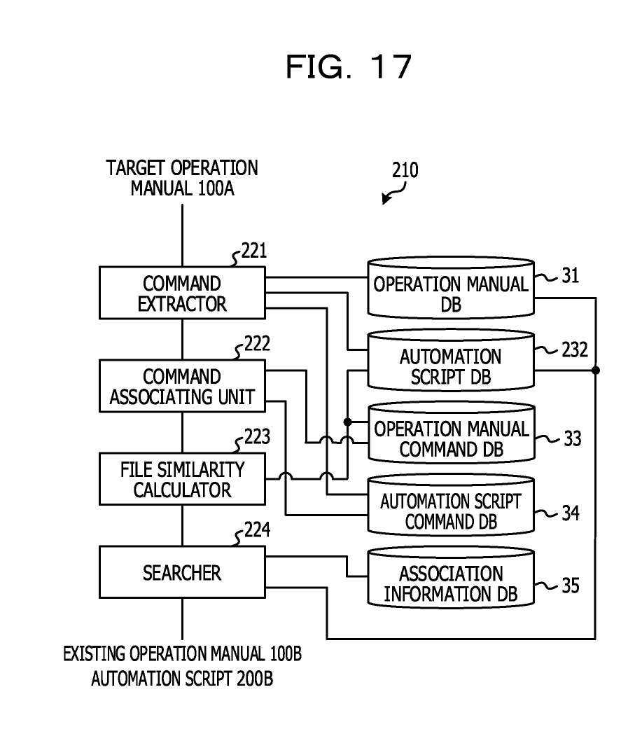

As illustrated in FIG. 17, a search device 210 according to the second embodiment includes a command extractor 221, a command associating unit 222, a file similarity calculator 223, and a searcher 224. In addition, the operation manual DB 31, an automation script DB 232, the operation manual command DB 33, and an automation script command DB 34, and an association information DB 35 are stored in a predetermined storage region of the search device 210.

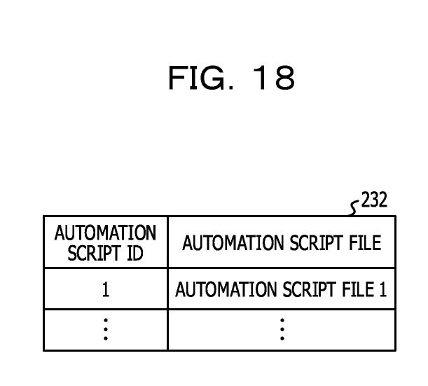

For example, as illustrated in FIG. 18, automation script IDs that identify the automation scripts 200B are given to files representing the automation scripts 200B and are stored in the automation script DB 232. The automation script DB 232 is different from the automation script DB 32 according to the first embodiment or does not include an item for the operation manual IDs of the existing operation manuals 100B from which the automation scripts 200B are generated.

The command extractor 221 extracts the commands from the command strings included in the input target operation manual 100A and the command strings 103 included in the existing operation manuals 100B stored in the operation manual DB 31 in the same manner as the command extractor 21 according to the first embodiment.

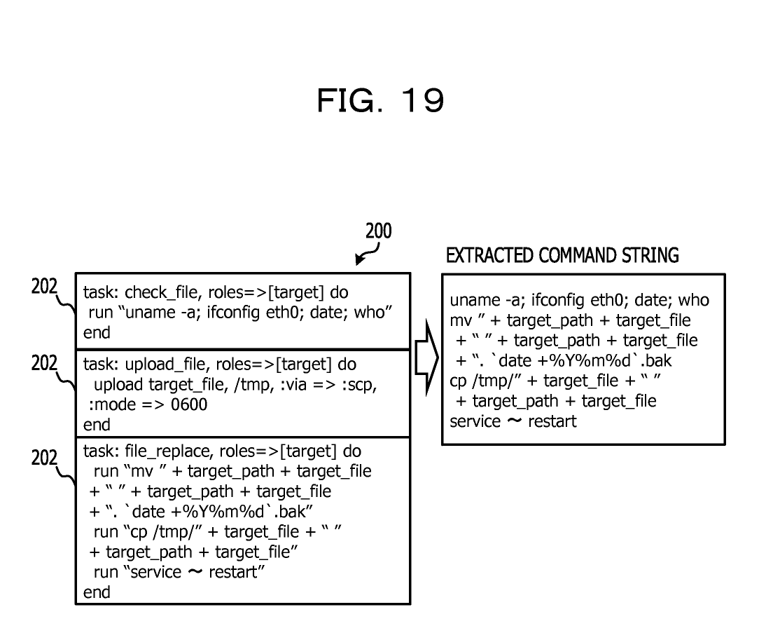

In addition, the command extractor 221 extracts the commands from the command strings 202 included in the automation scripts 200B stored in the automation script DB 232, as illustrated in FIG. 19. A rule for identifying descriptions of the commands of the automation scripts 200B based on a language of the automation scripts 200B may be defined in advance, and the commands may be extracted from the automation scripts 200B in accordance with the defined rule. For example, as illustrated in the example of FIG. 19, if a process to be executed in an information processing device to be subjected to settings is described in a control statement specified by “run”, the control statement specified by “run” may be extracted as a single command.

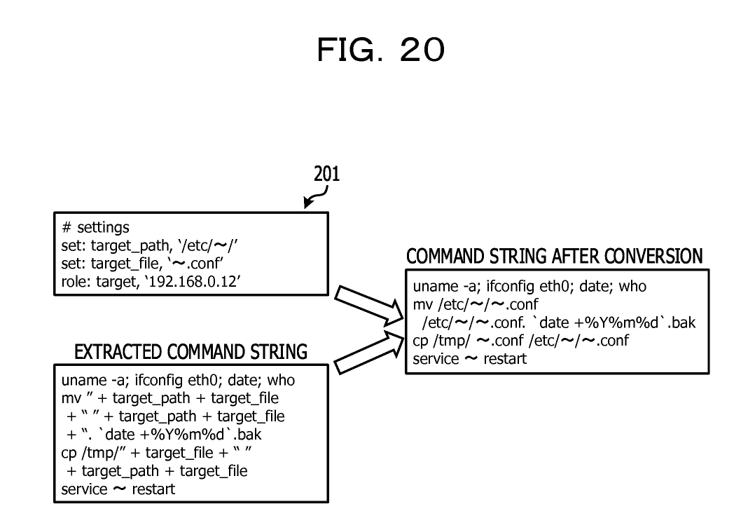

The command extractor 221 references conversion definitions 201 of the automation scripts 200 and reconverts a variable converted from a specific character string into the character string before the conversion in order to generate an automation script from an operation manual. For example, it is assumed that a conversion definition 201 illustrated in FIG. 20 is included in an automation script 200. In this example, the conversion definition 201 defines that a description “/etc/˜/” within an operation manual 100 is converted into “target_path” upon the generation of the automation script 200. A symbol “˜” within the conversion definition 201 is a part identifying specific information such as a server name, a software name, or a file name within the actual operation manual 100. As illustrated in FIG. 20, for example, a command “mv”+target_path+target_file” that is extracted from the automation script 200 is reconverted into a command “mv/etc/˜/˜.conf”.

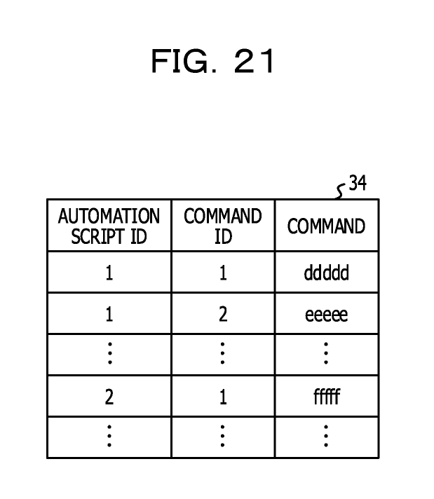

For example, as illustrated in FIG. 21, the command extractor 221 gives command IDs to the commands extracted from the automation scripts 200 or to commands reconverted based on the conversion definitions 201, in order of the appearance of the commands within the automation scripts 200. Then, the command extractor 221 associates the command IDs with the automation script IDs of the automation scripts 200 from which the commands are extracted and causes the command IDs and the automation script IDs to be stored in the automation script command DB 34.

The command associating unit 22 calculates similarities between the commands in order to calculate similarities between the target operation manual 100A and the existing operation manuals 100B and associates commands of the target operation manual 100A with commands of the existing operation manuals 100B in the same manner as the command associating unit 22 according to the first embodiment.

The command associating unit 222 associates commands extracted from the existing operation manuals 100B with commands extracted from the automation scripts 200B in order to calculate similarities between the existing operation manuals 100B and the automation scripts 200B. A specific method for the association is the same as or similar to the association of the commands extracted from the target operation manual 100A with the commands extracted from the existing operation manuals 100B, and a description thereof is omitted.

The file similarity calculator 223 calculates file similarities between the target operation manual 100A and the existing operation manuals 100B based on the results of associating the commands by the command associating unit 222, in the same manner as the file similarity calculator 23 according to the first embodiment.

In addition, the file similarity calculator 223 calculates file similarities between the existing operation manuals 100B and the existing automation scripts 200B based on the results of associating the commands by the command associating unit 222. A method of calculating the file similarities is the same as or similar to the method of calculating the file similarities between the target operation manual 100A and the existing operation manuals 100B, and a description thereof is omitted.

In addition, the file similarity calculator 223 extracts pairs of existing operation manuals 100B and automation scripts 200B between which calculated file similarities are equal to or larger than a predetermined threshold THf2. The pairs between which the file similarities are equal to or larger than the predetermined threshold THf2 are extracted due to the fact that even if a file similarity between an existing operation manual 100B and an automation script 200B is largest, the existing operation manual 100B may not be similar to the automation script 200B. Thus, if a file similarity between an existing operation manual 100B and an automation script 200B is smaller than the threshold THf2, the existing operation manual 100B is not associated with the automation script 200B. The threshold THf2 is set in advance based on accuracy requested for the search device or the like.

Each existing operation manual 100B may be associated with a respective automation script 200B. Each existing operation manual, however, may be associated with a number N of automation scripts. Alternatively, a number N of existing operation manuals may be associated with a single automation script or may be associated with a number N of automation scripts. For example, a pair of an existing operation manual 100B and automation script 200B between which a file similarity is equal to or larger than the predetermined threshold THf2 and is largest may be extracted. All automation scripts 200B of which file similarities with each existing operation manual 100B are equal to or larger than the predetermined threshold THf2 may be extracted. In addition, automation scripts 200B of which file similarities with each existing operation manual 100B are equal to or larger than the predetermined threshold THf2 and are the top N file similarities may be extracted.

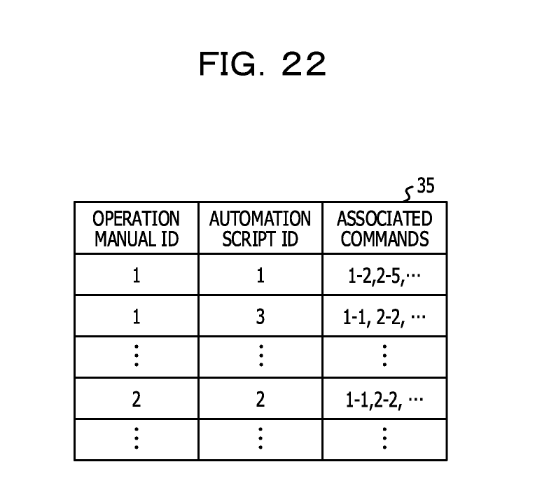

For example, as illustrated in FIG. 22, the file similarity calculator 223 associates the operational manual IDs of the existing operation manuals 100B of the extracted pairs with the automation script IDs of the automation scripts 200B of the extracted pairs and causes the operation manuals ID and the automation script IDs to be stored in the association information DB 35. In addition, the file similarity calculator 223 causes information of commands associated between the associated existing operation manuals 100B and the associated automation scripts 200B to be stored in the association information DB 35. For example, expressions obtained by coupling the command IDs of the commands associated with each other may be listed, associated with the operation manual IDs of the existing operation manuals 100B and the automation script IDs of the automation scripts 200B, and stored.

The searcher 224 searches, based on the file similarities between the target operation manual 100A and the existing operation manuals 100B, an existing operation manual 100B similar to the target operation manual 100B in the same manner as the searcher 24 according to the first embodiment. Then, the searcher 224 searches an automation script 200B associated with the searched existing operation manual 100B. The searcher 224 does not search the automation script 200B directly from the automation script DB 32 in the manner described in the first embodiment. The searcher 224 searches the automation script 200B associated with the existing operation manual 100B similar to the target operation manual 100A based on information stored in the association information DB 35.

Specifically, the searcher 224 acquires an automation script ID stored in a row in which the operation manual ID of the searched existing operation manual 100B is stored in an “operation manual ID” item of the association information DB 35. Then, the searcher 224 searches the automation script 200B from the automation script DB 232 based on the acquired automation script ID.

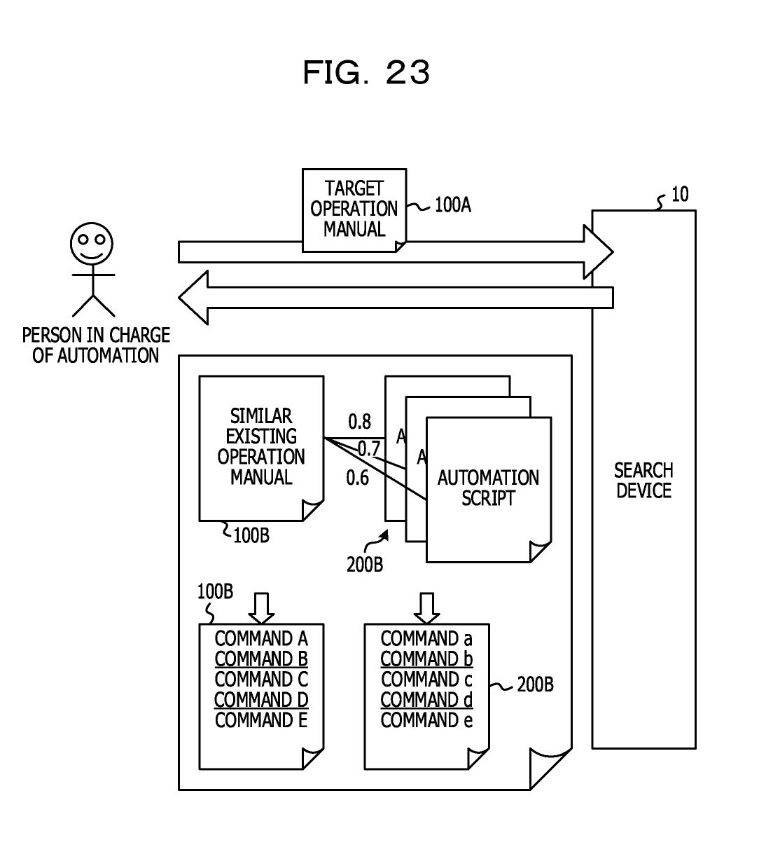

In addition, the searcher 224 presents commands associated between the searched existing operation manual 100B and the searched automation script 200B while presenting the searched existing operation manual 100B and the searched automation script 200B, as illustrated in FIG. 23, for example. In an example illustrated in FIG. 23, a command B included in the existing operation manual 100B and represented by a single underline and a command b included in the automation script 200B and represented by a single underline are associated with each other. In addition, a command D included in the existing operation manual 100B and represented by a double underline and a command d included in the automation script 200B and represented by a double underline are associated with each other.

In the second embodiment, the existing manuals 100B are associated with the automation scripts 200B in accordance with the file similarities based on the association of commands, as described above. Thus, a certain existing operation manual 100B may not be associated with an automation script 200B generated from the certain existing operation manual 100B. A command that is not associated between an existing operation manual 100B and an automation script 200B may not be used for the generation of the automation script 200A from the target operation manual 100A. Presenting commands associated between the existing operation manual 100B and the automation script 200B may support the person in charge of automation to determine whether or not the commands may be used when the person references the presented automation script 200B.

The search device 210 may be achieved by the computer 40 illustrated in FIG. 15, for example. A search program 250 that causes the computer 40 to function as the search device 210 is stored in the storage unit 43 serving as the storage medium. In addition, the storage unit 43 includes the operation manual storage region 61, an automation script storage region 262 for storing information forming the automation script DB 232, and the operation manual command storage region 63. In addition, the storage unit 43 includes an automation script command storage region 64 for storing information forming the automation script command DB 34 and an association information storage region 65 for storing information forming the association information DB 35.

The CPU 41 reads the search program 250 from the storage unit 43, loads the read search program 250 into the memory 42, and sequentially executes processes included in the search program 250. In addition, the CPU 41 reads the information stored in the automation script storage region 262 and loads the read information as the automation script DB 232 illustrated in FIG. 18 into the memory 42, for example. In addition, the CPU 41 reads the information stored in the automation script command storage region 64 and loads the read information as the automation script command DB 34 illustrated in FIG. 21 into the memory 42, for example. In addition, the CPU 41 reads the information stored in the association information storage region 65 and loads the read information as the association information DB 35 illustrated in FIG. 22 into the memory, for example. The other DBs are the same as the first embodiment.

The search program 250 includes a command extraction process 251, a command association process 252, a file similarity calculation process 253, and a search process 254. The CPU 41 operates as the command extractor 221 illustrated in FIG. 17 by executing the command extraction process 251. The CPU 41 operates as the command associating unit 222 illustrated in FIG. 17 by executing the command association process 252. The CPU 41 operates as the file similarity calculator 223 illustrated in FIG. 17 by executing the file similarity calculation process 253. The CPU 41 operates as the searcher 224 illustrated in FIG. 17 by executing the search process 254. Thus, the computer 40 that executes the search program 250 functions as the search device 210.

The search device 210 may be achieved by a semiconductor integrated circuit, for example. Specifically, the search device 210 may be achieved by an ASIC or the like.

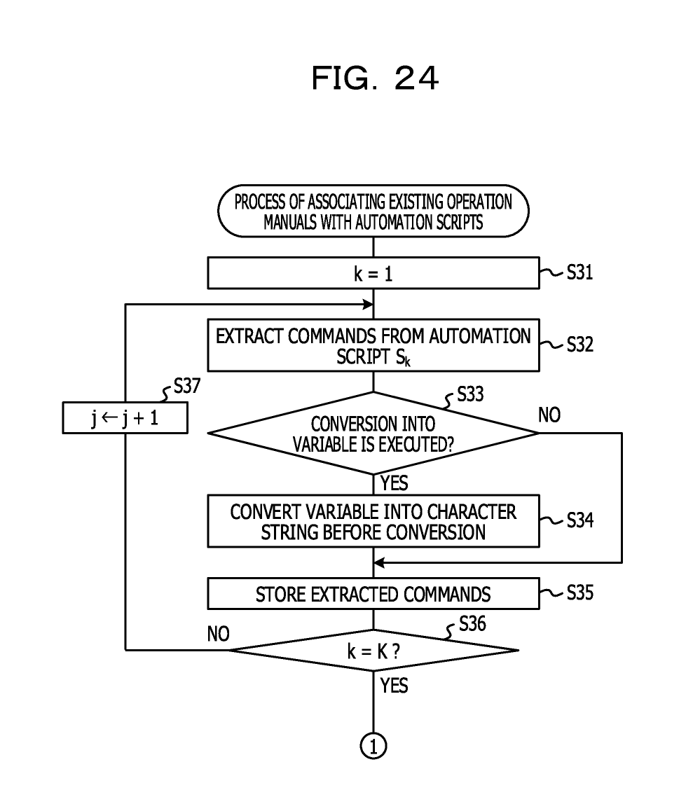

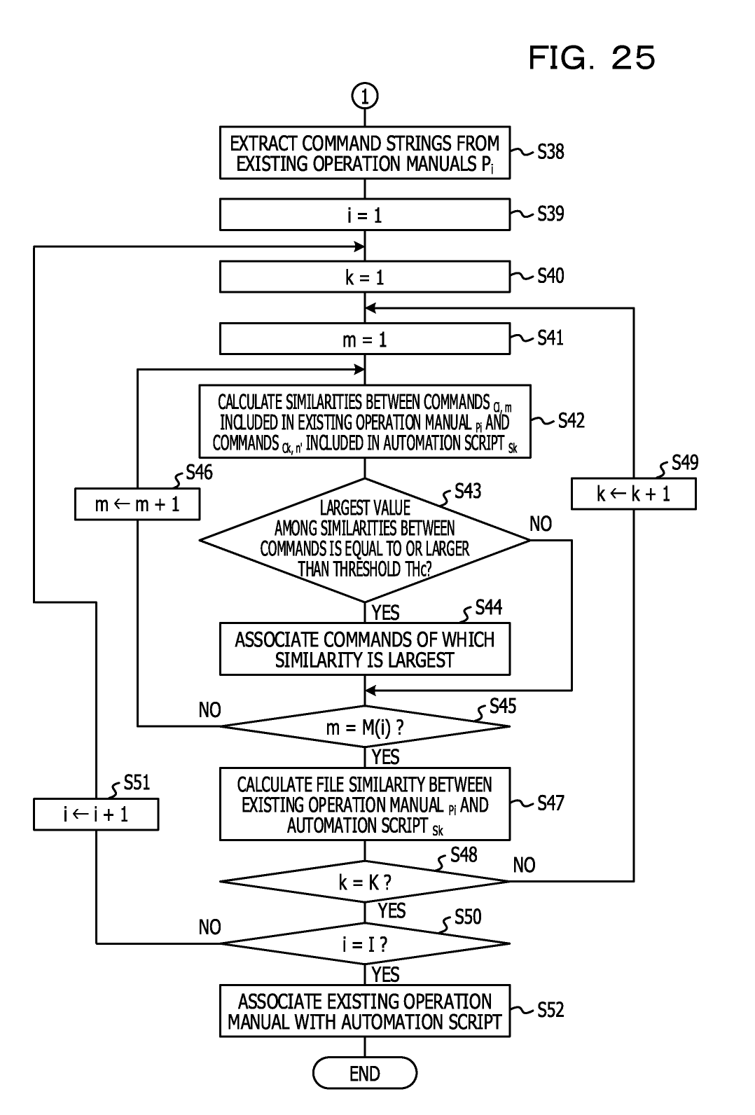

Next, effects of the search device 210 according to the second embodiment are described. In the second embodiment, before the search process described in the first embodiment, the search device 210 executes a process of associating existing operation manuals with automation scripts. The process of associating existing operation manuals with automation scripts is illustrated in FIGS. 24 and 25. The following assumes that sequential automation script IDs 1, 2, . . . are given to the automation scripts 200B stored in the automation script DB 232. In addition, an automation script 200B with an automation script ID=k is referred to as an “automation script Sₖ”. Sequential command IDs 1, 2, . . . are given to commands extracted from each of the automation scripts Sₖ. A command with a command ID=n extracted from the automation script Sₖ is referred to as a “command C_{k, n}”. A detailed description of processes that are the same as the search process according to the first embodiment is omitted.

In step S31 of the process (illustrated in FIG. 24) of associating existing operation manuals with automation scripts, the command extractor 221 sets, to 1, a variable k for identifying an automation script Sₖ to be processed. The variable k is 1, 2, . . . , K, while K is the number of the automation scripts 200B stored in the automation script DB 232.

Next, in step S32, the command extractor 221 extracts commands from command strings 202 included in the automation script Sₖ. In step S33, the command extractor 221 references a conversion definition 201 of the automation script Sₖ and determines whether or not a part at which a specific character string is converted into a variable upon the generation of the automation script from an operation manual exists. If the part exists, the process proceeds to step S34, the command extractor 221 reconverts the variable converted from the specific character string into the character string, and the process proceeds to step S35. On the other hand, if the part does not exist, the process skips step S34 and proceeds to step S35.

In step S35, the command extractor 221 gives command IDs to the commands extracted from the automation script Sₖ or commands reconverted based on the conversion definition 201 in order of the appearance of the commands within the automation script Sₖ. Then, the command extractor 221 associates the command IDs with the automation script ID of the automation script Sₖ from which the commands are extracted and causes the command IDs and the automation script ID to be stored in the automation script command DB 34.

Next, in step S36, the command extractor 221 determines whether or not the variable k reaches K, and the command extractor 221 thereby determines whether or not the process of extracting commands is executed on all the automation scripts Sₖ included in the automation script DB 232. If the variable k does not reach K, the process proceeds to step S37, the command extractor 221 increments the variable k by 1, and the process returns to step S32. If the variable k reaches K, the process proceeds to step S38 illustrated in FIG. 25.

In step S38, the command extractor 221 extracts commands from command strings 103 included in the existing operation manuals Pᵢ stored in the operation manual DB 31. Then, the command extractor 221 gives command IDs to the extracted commands in order of the appearance of the commands within the existing operation manuals Pᵢ, associates the command IDs with the operation manual IDs (i) of the operation manuals Pᵢ from which the commands are extracted, and causes the commands, the command IDs, and the operation manual IDs (i) to be stored in the operation manual command DB 33.

Next, in step S39, the command associating unit 222 sets, to 1, the variable i for identifying an existing operation manual Pᵢ to be processed. Next, in step S40, the command associating unit 222 sets, to 1, the variable k for identifying an automation script Sₖ to be processed. Next, in step S41, the command associating unit 222 sets, to 1, a variable m for identifying a command c_{i, m} to be processed among commands included in the existing operation manual Pᵢ.

Next, in step S42, the command associating unit 222 calculates similarities between the command c_{i, m} of the existing operation manual Pᵢ and commands C_{k, n′} of the automation script Sₖ. In this case, n=1, 2, . . . , N(i), while N(i) is the number of commands included in the automation script Sₖ. In addition, n′ represents the commands excluding a command preceding the command associated with the command c_{i, m} of the existing operation manual Pᵢ.

Next, in step S43, the command associating unit 222 determines whether or not the largest value among the similarities calculated in the aforementioned step S42 is equal to or larger than the threshold THc. If the largest value among the similarities is equal to or larger than the threshold THc, the process proceeds to step S44. In step S44, the command associating unit 222 associates a pair of the operation manual ID (i) of the existing operation manual Pᵢ and the command ID (m) of the command c_{i, m} with a pair of the automation script ID (k) of the automation script Sₖ and the command ID of a command C_{k, n′} of which a similarity with the command c_{i, m} is largest among the calculated similarities. Then, the command associating unit 222 causes the associated pairs to be temporarily stored in the predetermined storage region and the process proceeds to step S45. On the other hand, if the largest value among the similarities is smaller than the threshold THc in the aforementioned step S43, the process skips step S44 and proceeds to step S45.

In step S45, the command associating unit 222 determines whether or not the variable m reaches M(i), and the command associating unit 222 thereby determines whether or not a process of associating all commands included in the existing operation manual Pᵢ with commands included in the automation script Sₖ is executed. If the variable m does not reach M(i), the process proceeds to step S46, the command associating unit 222 increments the variable m by 1, and the process returns to step S42. If the variable m reaches M(i), the process proceeds to step S47.

In step S47, the file similarity calculator 223 calculates a file similarity between the existing operation manual Pᵢ and the automation script Sₖ based on the results of associating the commands by the command associating unit 222. The file similarity calculator 223 associates the calculated file similarity with the operation manual ID (i) of the existing operation manual Pᵢ and the automation script ID (k) of the automation script Sₖ and causes the file similarity, the operation manual ID (i), and the automation script ID (k) to be temporarily stored in the predetermined storage region.

Next, in step S48, the file similarity calculator 223 determines whether or not the variable k reaches K. By making the determination, the file similarity calculator 223 determines whether or not a process of calculating file similarities between the existing operation manual Pᵢ and all the automation scripts Sₖ stored in the automation script DB 32 is executed. If the variable k does not reach K, the process proceeds to step S49, the file similarity calculator 223 increments the variable k by 1, and the process returns to step S41. If the variable k reaches K, the process proceeds to step S50.

In step S50, the file similarity calculator 223 determines whether or not the variable i reaches I. By making the determination, the file similarity calculator 223 determines whether or not a process of calculating file similarities between all the existing operation manuals Pᵢ stored in the operation manual DB 31 with all the automation scripts Sₖ stored in the automation script DB 32 is executed. If the variable i does not reach I, the process proceeds to step S51, the file similarity calculator 223 increments the variable i by 1, and the process returns to step S40. If the variable i reaches I, the process proceeds to step S52.

In step S52, the file similarity calculator 223 extracts pairs of existing operation manuals Pᵢ and automation scripts Sₖ of which calculated file similarities with the existing operation manuals Pᵢ are equal to or larger than the predetermined threshold THf2. Then, the file similarity calculator 223 associates the operation manual IDs (i) of the existing operation manuals Pᵢ of the extracted pairs with the automation script IDs (k) of the automation scripts Sₖ of the extracted pairs and causes the operation manuals IDs (i) and the automation script IDs (k) to be stored in the association information DB 35. In addition, the file similarity calculator 223 causes information of commands associated between the associated existing operation manuals Pᵢ and the associated automation scripts Sₖ to be stored in the association information DB 35 and terminates the process of associating existing operation manuals with automation scripts.

The search process may be executed in the same manner as the first embodiment. In the second embodiment, the process of extracting commands from the existing operation manuals is executed in the process of associating existing operation manuals with automation scripts. Thus, in the search process according to the second embodiment, the process of extracting commands from the existing operation manuals may be omitted in step S11 illustrated in FIG. 16. In addition, in step S22 of the search process illustrated in FIG. 16, the associated commands are presented upon the presentation of the searched existing operation manual and the searched automation script.

As described above, the search device 210 according to the second embodiment associates commands of existing operation manuals with commands of automation scripts while maintaining the orders of commands of command strings included in the existing operation manuals and the orders of commands of command strings included in the automation scripts and associates the existing operation manuals with the automation scripts based on the results of associating the commands. Then, the search device 210 according to the second embodiment searches an existing operation manual similar to the target operation manual and an automation script associated with the searched existing operation manual in the same manner as the first embodiment. Thus, the associations of the existing operation manuals with the automation scripts may be automatically executed, while the effects of the first embodiment are obtained.

Although the embodiments describe the case where file similarities are calculated based on the results of associating commands, the embodiments are not limited to this. For example, if a relationship between an existing operation manual and an automation script is determined to be high using information representing that the same responsible person generates the existing operation manual and the automation script or using information representing that a time and date when the existing operation manual is generated is close to a time and data when the automation script is generated, a file similarity between the existing operation manual and the automation script may be calculated to be high.

In addition, information that represents whether or not a presented existing operation manual and a presented automation script are used as references for generation of an automation script from a target operation manual may be fed back and reflected in file similarities and command similarities that will be calculated subsequent times.

Although the cases where the search programs 50 and 250 are stored (installed) in the storage unit 43 in advance are described above, the search programs 50 and 250 may be stored in a storage medium such as a CD-ROM, a DVD-ROM, or a USB memory and provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A search method comprising:
extracting a plurality of processes from a target operation manual from which automation software that is obtained by converting, into a plurality of commands, the plurality of processes included in the target operation manual describing a procedure for configuring settings in an information processing device is generated;
comparing the plurality of processes extracted from the target operation manual with a plurality of processes included in each of a plurality of existing operation manuals stored in a storage device storing the existing operation manuals and automation software generated from the existing operation manuals and associated with the existing operation manuals while maintaining the orders of the pluralities of processes;
calculating, by a processor, first similarities that are similarities between the existing operation manuals and the target operation manual based on the comparing; and
searching, based on the calculated first similarities, an existing operation manual similar to the target operation manual and automation software associated with the existing operation manual and stored in the storage device.

2. The search method according to claim 1,
wherein the first similarities are calculated based on the ratio of the number of processes, which are included in each of the existing manuals and associated with processes included in the target operation manual so as to ensure that the order of processes included in the target operation manual and the order of processes included in the existing operation manual are maintained and which each have the largest second similarity with a process included in the target operation manual among second similarities between the process included in the target operation manual and processes included in the existing operation manual, to at least any of the number of the processes included in the target operation manual and the number of the processes included in the existing operation manual.

3. The search method according to claim 2, wherein
the calculating is executed based on the results of associating, for each of the existing operation manuals, a process included in the target operation manual with a process that is included in the existing operation manual and of which a second similarity with the process included in the target operation manual is equal to or larger than a predetermined threshold and largest among second similarities between the process included in the target operation manual and processes included in the existing operation manual so as to ensure that the order of the processes included in the target operation manual and the order of processes included in the existing operation manual are maintained.

4. The search method according to claim 2, further comprising:
extracting a plurality of processes included in each of the existing operation manuals;
extracting a plurality of commands included in the automation software;
comparing a plurality of processes extracted from each of the existing operation manuals with the plurality of commands extracted from the automation software while maintaining the orders of the extracted processes and the orders of the extracted commands; and
associating the existing operation manuals with the automation software based on the comparing of the plurality of processes extracted from each of the existing operation manuals with the plurality of commands extracted from the automation software.

5. The search method according to claim 4, wherein
when the plurality of commands is converted from character strings into variables upon conversion of the processes into the commands, the comparing of the plurality of processes extracted from each of the existing operation manuals with the plurality of commands extracted from the automation software is executed after the variables of the commands extracted from the automation software are converted into the character strings before the conversion or after character strings of the processes extracted from the existing operation manuals are converted into variables.

6. The search method according to claim 4, wherein
the existing operation manuals are associated with the automation software based on the ratio of processes, which are included in each of the existing operation manuals and associated commands included in the automation software so as to ensure that the order of processes included in the existing operation manual and the order of the commands included in the automation software are maintained and which each have a second similarity with a command included in the automation software that is equal to or larger than a predetermined threshold and is largest among second similarities between the process included in the existing operation manual and commands included in the automation software, to at least any of the number of the processes included in the existing operation manual and the number of the commands included in the automation software.

7. A search device comprising:
a storage device configured to store the existing operation manuals and automation software generated from the existing operation manuals and associated with the existing operation manuals;
a processor coupled to the storage device and configured to:
extract a plurality of processes from a target operation manual from which automation software that is obtained by converting, into a plurality of commands, the plurality of processes included in the target operation manual describing a procedure for configuring settings in an information processing device is generated,
compare the plurality of processes extracted from the target operation manual with a plurality of processes included in each of a plurality of existing operation manuals in the storage device while maintaining the orders of the pluralities of processes,
calculate first similarities that are similarities between the existing operation manuals and the target operation manual based on the comparison of the plurality of processes extracted from the target operation manual with a plurality of processes included in each of a plurality of existing operation manuals, and
search, based on the calculated first similarities, an existing operation manual similar to the target operation manual and automation software associated with the existing operation manual and stored in the storage device.

8. The search device according to claim 7, wherein
the first similarities are calculated based on the ratio of the number of processes, which are included in each of the existing manuals and associated with processes included in the target operation manual so as to ensure that the order of processes included in the target operation manual and the order of processes included in the existing operation manual are maintained and which each have the largest second similarity with a process included in the target operation manual among second similarities between the process included in the target operation manual and processes included in the existing operation manual, to at least any of the number of the processes included in the target operation manual and the number of the processes included in the existing operation manual.

9. The search device according to claim 8, wherein
the calculation of the first similarities is executed based on the results of associating, for each of the existing operation manuals, a process included in the target operation manual with a process that is included in the existing operation manual and of which a second similarity with the process included in the target operation manual is equal to or larger than a predetermined threshold and largest among second similarities between the process included in the target operation manual and processes included in the existing operation manual so as to ensure that the order of the processes included in the target operation manual and the order of processes included in the existing operation manual are maintained.

10. The search device according to claim 8, wherein the processor is further configured to:
extract a plurality of processes included in each of the existing operation manuals,
extract a plurality of commands included in the automation software,
compare a plurality of processes extracted from each of the existing operation manuals with the plurality of commands extracted from the automation software while maintaining the orders of the extracted processes and the orders of the extracted commands, and
associate the existing operation manuals with the automation software based on the comparing of the plurality of processes extracted from each of the existing operation manuals with the plurality of commands extracted from the automation software.

11. The search device according to claim 10, wherein
when the plurality of commands is converted from character strings into variables upon conversion of the processes into the commands, the comparison of the plurality of processes extracted from each of the existing operation manuals with the plurality of commands extracted from the automation software is executed after the variables of the commands extracted from the automation software are converted into the character strings before the conversion or after character strings of the processes extracted from the existing operation manuals are converted into variables.

12. The search device according to claim 10, wherein
the existing operation manuals are associated with the automation software based on the ratio of processes, which are included in each of the existing operation manuals and associated commands included in the automation software so as to ensure that the order of processes included in the existing operation manual and the order of the commands included in the automation software are maintained and which each have a second similarity with a command included in the automation software that is equal to or larger than a predetermined threshold and is largest among second similarities between the process included in the existing operation manual and commands included in the automation software, to at least any of the number of the processes included in the existing operation manual and the number of the commands included in the automation software.

13. A non-transitory computer-readable storage medium storing therein a search program that causes a computer to execute a process, the process comprising:
extracting a plurality of processes from a target operation manual from which automation software that is obtained by converting, into a plurality of commands, the plurality of processes included in the target operation manual describing a procedure for configuring settings in an information processing device is generated;
comparing the plurality of processes extracted from the target operation manual with a plurality of processes included in each of a plurality of existing operation manuals stored in a storage device storing the existing operation manuals and automation software generated from the existing operation manuals and associated with the existing operation manuals while maintaining the orders of the pluralities of processes;
calculating first similarities that are similarities between the existing operation manuals and the target operation manual based on the comparing; and
searching, based on the calculated first similarities, an existing operation manual similar to the target operation manual and automation software associated with the existing operation manual and stored in the storage device.

14. The storage medium according to claim 13, wherein
the first similarities are calculated based on the ratio of the number of processes, which are included in each of the existing manuals and associated with processes included in the target operation manual so as to ensure that the order of processes included in the target operation manual and the order of processes included in the existing operation manual are maintained and which each have the largest second similarity with a process included in the target operation manual among second similarities between the process included in the target operation manual and processes included in the existing operation manual, to at least any of the number of the processes included in the target operation manual and the number of the processes included in the existing operation manual.

15. The storage medium according to claim 14, wherein
the calculating is executed based on the results of associating, for each of the existing operation manuals, a process included in the target operation manual with a process that is included in the existing operation manual and of which a second similarity with the process included in the target operation manual is equal to or larger than a predetermined threshold and largest among second similarities between the process included in the target operation manual and processes included in the existing operation manual so as to ensure that the order of the processes included in the target operation manual and the order of processes included in the existing operation manual are maintained.

16. The storage medium according to claim 14, the process further comprising:
extracting a plurality of processes included in each of the existing operation manuals;
extracting a plurality of commands included in the automation software;
comparing a plurality of processes extracted from each of the existing operation manuals with the plurality of commands extracted from the automation software while maintaining the orders of the extracted processes and the orders of the extracted commands; and
associating the existing operation manuals with the automation software based on the comparing of the plurality of processes extracted from each of the existing operation manuals with the plurality of commands extracted from the automation software.

17. The storage medium according to claim 16, wherein
when the plurality of commands is converted from character strings into variables upon conversion of the processes into the commands, the comparing of the plurality of processes extracted from each of the existing operation manuals with the plurality of commands extracted from the automation software is executed after the variables of the commands extracted from the automation software are converted into the character strings before the conversion or after character strings of the processes extracted from the existing operation manuals are converted into variables.

18. The storage medium according to claim 16, wherein
the existing operation manuals are associated with the automation software based on the ratio of processes, which are included in each of the existing operation manuals and associated commands included in the automation software so as to ensure that the order of processes included in the existing operation manual and the order of the commands included in the automation software are maintained and which each have a second similarity with a command included in the automation software that is equal to or larger than a predetermined threshold and is largest among second similarities between the process included in the existing operation manual and commands included in the automation software, to at least any of the number of the processes included in the existing operation manual and the number of the commands included in the automation software.
